(19) United States
(12) Patent Application Publication
(10) Pub. No.: US 2010/0264285 A1
(43) Pub. Date: Oct. 21, 2010

(54) SUCTION DEVICE FOR SECURING A TETHER

(75) Inventor: Terrence J. Buelna, Santa Barbara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TBest, Inc., Templeton, CA (US)

(21) Appl. No.: 12/424,372

(22) Filed: Apr. 15, 2009

(51) Int. Cl. F16B 47/00

(52) U.S. Cl. 248/205.8

(57) ABSTRACT

Methods and devices for adhering and securing a tether to a surface are provided. A suction device comprises a base having a top portion and a bottom cavity, a lever, and a flexible suction skirt. The lever has a bottom end, a cam element pivotally coupled to the lever's bottom end and traversing the base's top portion, and at least one cleat along a side of the lever for capturing a tether. The skirt is disposed within the base's bottom cavity and is coupled to the lever's cam element. Closing the lever from a vertical to a horizontal orientation relative to the base causes the cam element to pull the flexible suction skirt to deform the flexible suction skirt, applying suction on the surface and simultaneously moving the cleat horizontally with respect to the base to cinch the captured tether.

### BACKGROUND OF THE INVENTION

The invention generally relates to securing an object onto a surface. More particularly, the invention relates to securing a tether onto a surface using a suction device.

For various reasons, people may want objects to be supported on surface such as walls, window panes, mirrors, automobile windshields, automobile exteriors, etc. Suction devices provide a means of such support and do not require the surface to be pierced as would be the case for connectors such as nails or screws.

A commonly used suction device for supporting an object on a surface is a single suction cup attached to a hook. An issue with this and similar simple devices is that air can easily enter the space between the surface and the suction cup, causing the suction cup to be detached or more easily detachable from the surface. A suction cup with an object weighing down on its hook is especially susceptible to this cause of detachment. Another issue with such simple devices is that a simple hook may not be sufficient to hold onto objects very tightly. Therefore, improved devices and methods of securing objects to a surface with suction are desired.

Patents and publications of interest may include U.S. Pat. No. 355,021 to Lang; U.S. Pat. No. 6,244,778 to Chesbrough; U.S. Pat. No. 6,308,923 to Howard; U.S. Pat. No. 6,402,104 to Smith; U.S. Pat. No. 6,550,735 to Zheng; and U.S. Pat. No. 7,066,434 to Kwok.

### BRIEF SUMMARY OF THE INVENTION

Embodiments of the invention provide methods and suction devices for adhering and securing a tether, for example, a rope, a bungee cord, or an elastic band, to a surface. An exemplary suction device comprises a base, a lever, and a flexible suction skirt. The base has a top portion and a bottom cavity. The lever has a bottom end, a cam element, and at least one cleat. The cam element of the lever is pivotally coupled to the bottom end of the lever and traverses the top portion of the base. The at least one cleat of the lever is typically a plurality of cleats and is disposed along a side of the lever for capturing the tether. The cleat will generally be oriented to face away from the base. The lever may comprise a lever arm and the cleats may be offset from the elongate lever arm to form hooks for capturing the tether. The skirt is disposed within the bottom cavity of the base and is coupled to the cam element of the lever. Typically, the suction device also comprises a ring for the tether to thread through. To capture at tether, the tether may be passed through the ring in a first direction toward the lever, hooked onto a cleat, and then passed through the ring in a second direction away from the lever. The lever can be closed from a vertical orientation relative to the base to a horizontal orientation relative to the base. Closing the lever causes the cam element to pull the flexible suction skirt to deform the flexible suction skirt, applying suction on the surface and simultaneously moving the cleat horizontally with respect to the base to cinch a captured tether.

Embodiments of the invention may also comprise a system and method for holding down an object to a surface or a compartment, for example, a truck bed. The system comprises a continuous loop of tether, a first suction device, and a second suction device. To hold an object to a surface, the following steps may be taken. A peripheral portion of a flexible suction skirt of the first suction device is placed adjacent the surface at a first side of the object. A peripheral portion of the second suction device is placed adjacent the surface at a second side of the object. The continuous loop of tether is captured with at least one cleat of a lever of the first suction device. For example, the continuous loop of the tether may be passed through a ring of the first suction device and/or hooked onto the at least one cleat of the lever. The continuous loop of tether is placed over the object. The continuous loop of tether is captured with at least one cleat of a lever of the second suction device. For example, the continuous loop of the tether may be passed through a ring of the second suction device and/or hooked onto the at least one cleat of the lever. The levers of the first and second suction devices are then closed from a vertical orientation relative to their bases to a horizontal orientation relative to their bases. Closing the lever causes cam elements coupled to the lever to pull middle portions of the suction devices' flexible suction skirts from their peripheral portions, deforming the flexible suction skirts and applying suction on the surface. Closing the lever also moves the at least one cleat of the levers horizontally with respect to the bases of the suction devices to cinch the captured tether.

### BRIEF DESCRIPTION OF THE DRAWINGS

FIG. 1 shows a perspective view of a suction device according to embodiments of the invention;

FIGS. 2A and 2B shows cross-sectional views of the suction device of FIG. 1 in its unlocked and locked configuration, respectively;

FIG. 3 shows a top view of the suction device of FIG. 1;

FIG. 3A shows a cross-sectional view of the suction device of FIG. 1;

FIGS. 4A to 4D show a method of securing a tether using the suction device of FIG. 1;

FIG. 5 shows the suction device of FIG. 1 and a tether used to attach a tarpaulin to a truck bed;

FIGS. 5A to 5C show a method of securing a loop of tether using the suction device of FIG. 1;

FIG. 5D shows a magnified view of the suction device attaching the tarpaulin to a truck bed as in FIG. 5;

FIGS. 6 and 6A show a perspective view and a back view, respectively, of an object held down to a truck bed using traditional bungee cords;

FIG. 6B shows the traditional bungee cord of FIGS. 6 and 6A;

FIGS. 7 and 7A show a perspective view and a back view, respectively, of an object held down to a truck bed using a system comprising the suction devices of FIG. 1; and

FIG. 7B shows the suction device system of FIG. 7.

### DETAILED DESCRIPTION OF THE INVENTION

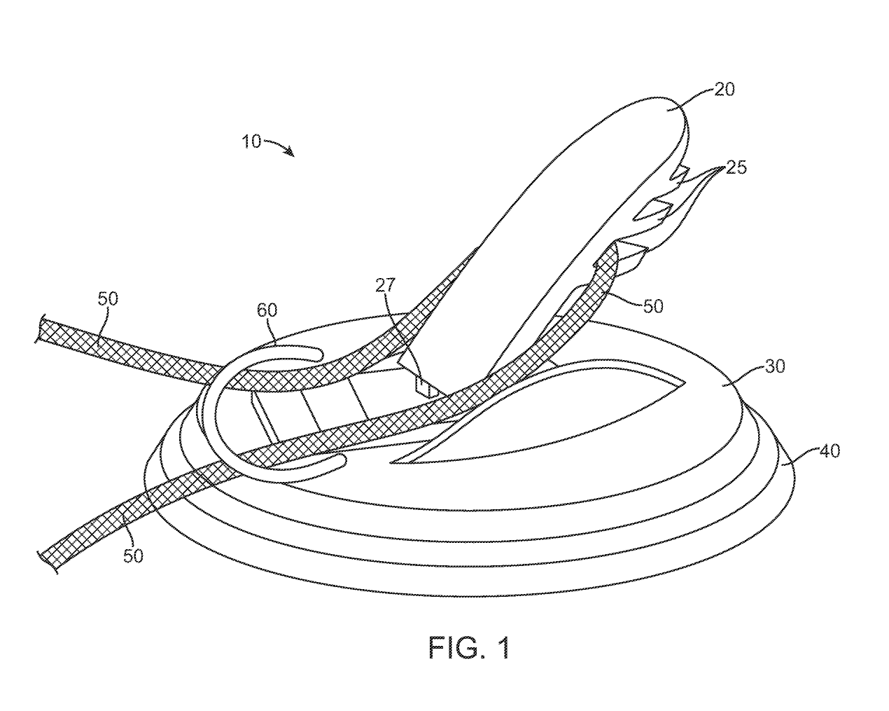

FIG. 1 shows a perspective view of a suction device 10 according to embodiments of the invention. The suction device 10 comprises a lever 20, a base 30, a flexible suction skirt 40, and a ring 60. The lever 20 comprises a plurality of cleats 25 and a cam 27 pivotally coupled to the bottom portion of the lever 20. As shown in FIG. 1, the suction device 10 can be coupled to a tether 50. The tether 50 is passed in through the ring 60, hooked onto a cleat. 25, and passed out through the ring 60. The cleats 25 along a side of the lever 20 and are oriented to face away from the base 20. The lever 20 may comprise a lever arm and the cleats 25 are offset from the elongate lever arm to form hooks for capturing the tether 50.

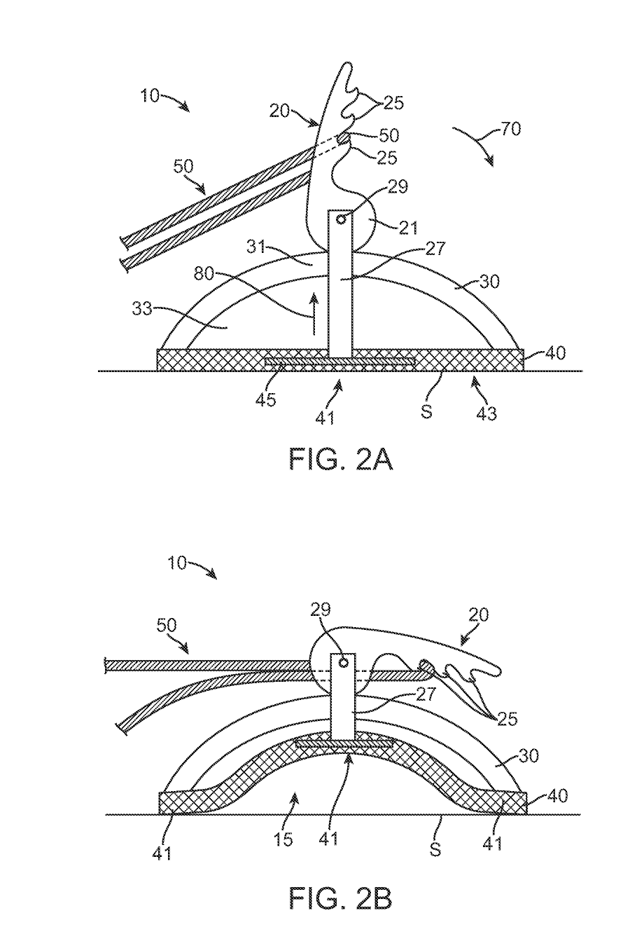

The suction device 10 has an unlocked configuration and a locked configuration. FIG. 2A shows a cross-sectional view of the suction device 10 in its unlocked configuration and FIG. 2B shows a cross-sectional view of the suction device 10 in its locked configuration.

As shown in FIG. 2A, the lever 20 is vertical relative to the base 30 in the suction device 10's unlocked configuration. The lever 20 is pivotally coupled to the cam 27 at a pivot point 29. The cam element 27 is coupled to the middle portion 41 of the flexible suction skirt 40 with a coupling element 45. As shown in FIGS. 2A and 2B, the coupling element 45 is a disc attached to the bottom of the cam 27 and disposed within the middle portion 41 of the flexible suction skirt 40. In some embodiments, the coupling element may be a disc attached to the bottom of the cam 27 and adhered to the top surface of the middle portion 41 of the flexible suction skirt 40. The cam 27 traverses the top portion 31 of the base 30 and crosses into the bottom cavity 33 of the base 30. FIG. 2A shows the suction device 10 placed against a surface S, with both the middle portion 41 and the peripheral portion 43 of the flexible suction skirt 40 contacting the surface S. The tether 50 is hooked onto one of the cleats 25.

The suction device 10 is placed into its locked configuration from its unlocked configuration by closing the lever 20 in the direction indicated by arrow 70. Closing the lever 20 causes the cam 27 to pull the middle portion 41 of the flexible suction skirt 40 up into the bottom cavity 33 as indicated by arrow 80. The middle portion 41 is pulled, for example, by having the bottom portion 21 of the lever 20 shaped so that the distance between the pivot point 29 and the top surface of the base 30 is greater when the lever 20 is horizontal relative to the base 30 than when the lever 20 is vertical relative to the base 30.

As shown in FIG. 2B, the lever 20 is horizontal relative to the base 30 when the lever 20 is closed, i.e., in the suction device 10's locked configuration. While the peripheral portion 43 of the flexible suction skirt 40 remains contacting the surface S, the middle portion 41 is pulled away, forming a vacuum in the space 15 between the middle portion 41 and the surface S.

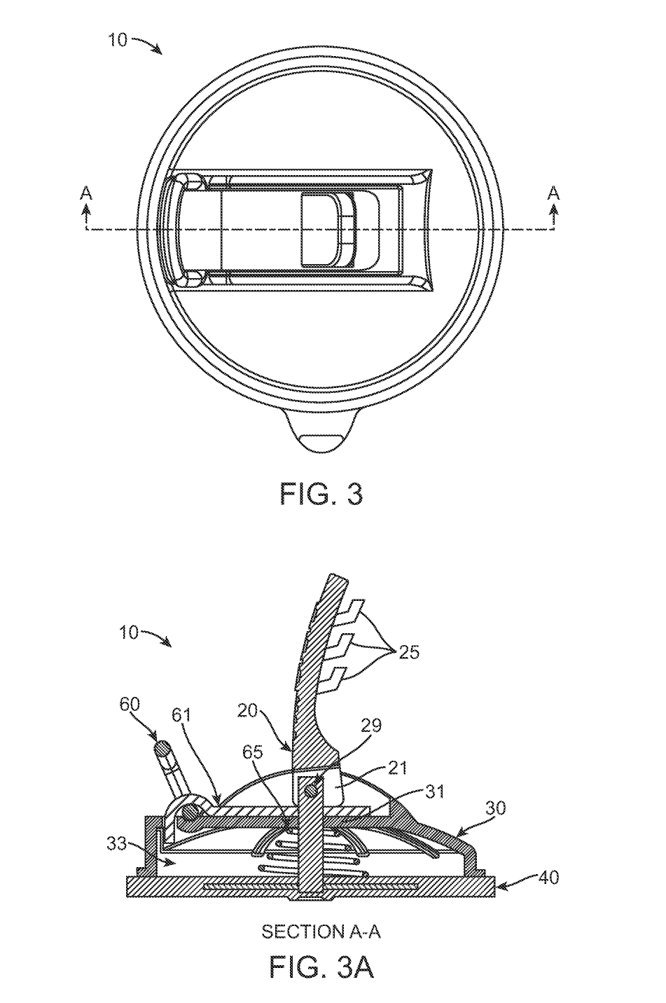

FIG. 3 shows a top view of the suction device 10 in its unlocked configuration. FIG. 3A shows a cross-sectional view of the suction device 10 taken across section A-A in FIG. 3. In some embodiments, the suction device 10 may comprise a helical coil spring 65 disposed within the bottom cavity 33 of the base 30 between the top portion 31 of the base 30 and the top surface of the flexible suction skirt 40. The spring 65 is biased to maintain the relative positions of the flexible suction skirt 40 and the top portion 31 of the base 30 as shown in FIG. 3A. The spring 65 therefore provides a degree of resistance as the lever 20 is closed and the middle portion 41 of the flexible suction skirt 40 is pulled up. In some embodiments, the suction device 10 may comprise a tie down part 61 which couples the ring 60 to the base 30.

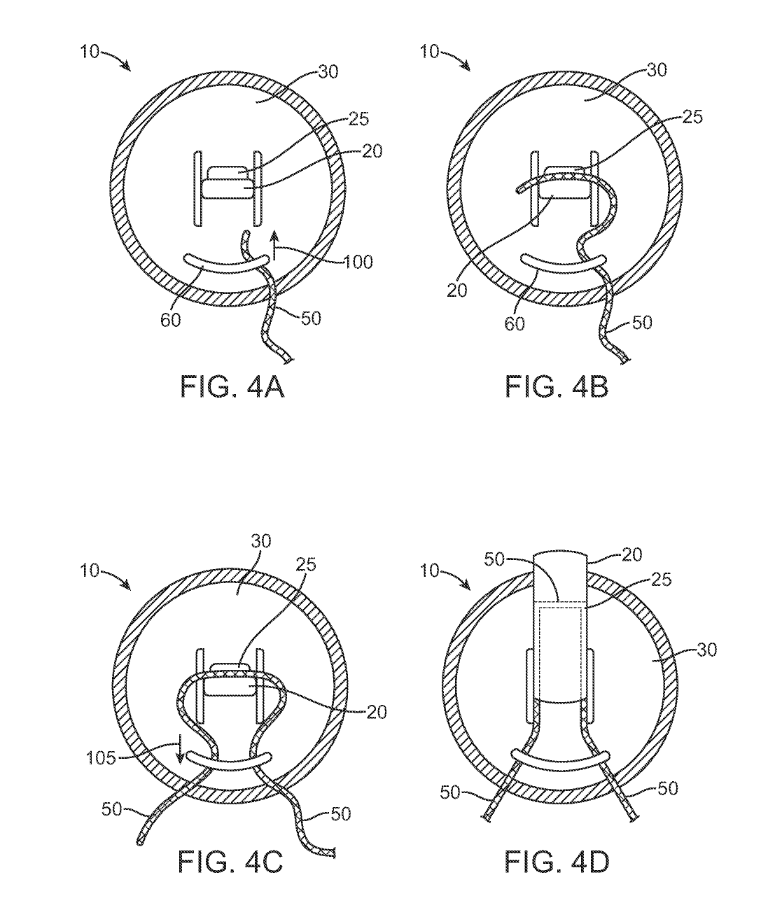

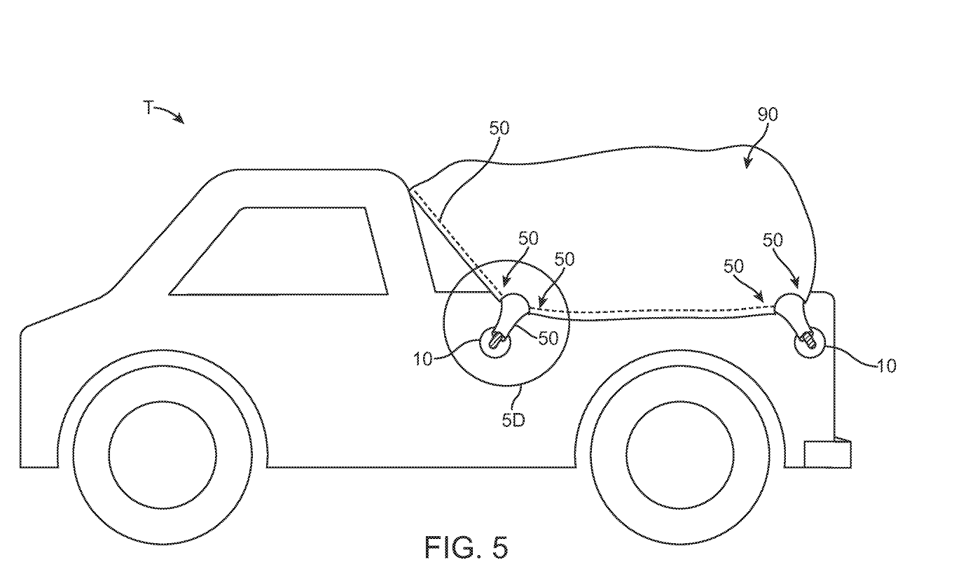

FIGS. 4A to 4D show a method of securing the tether 50 using the suction device 10. As shown in FIG. 4A, the tether 50 is passed in through the ring 60 in a first direction toward the lever 20 as indicated by arrow 100. As shown in FIG. 4B, the tether 50 is then hooked onto a cleat 25 which captures the tether 50. As shown in FIG. 4C, the tether 50 is then passed out through the ring 60 in a second direction away from the lever 20 as indicated by arrow 105. As shown in FIG. 4D, the suction device 10 is put into its locked configuration by closing lever 20. This moves the cleat 25 horizontally with respect to the base 30 to cinch the captured tether 50 and tighten it.

Although only the above exemplary steps are described, it can be appreciated by those of ordinary skill in the art that the above-described steps may be performed in any order, additional related steps may be performed, and certain steps may be modified or omitted.

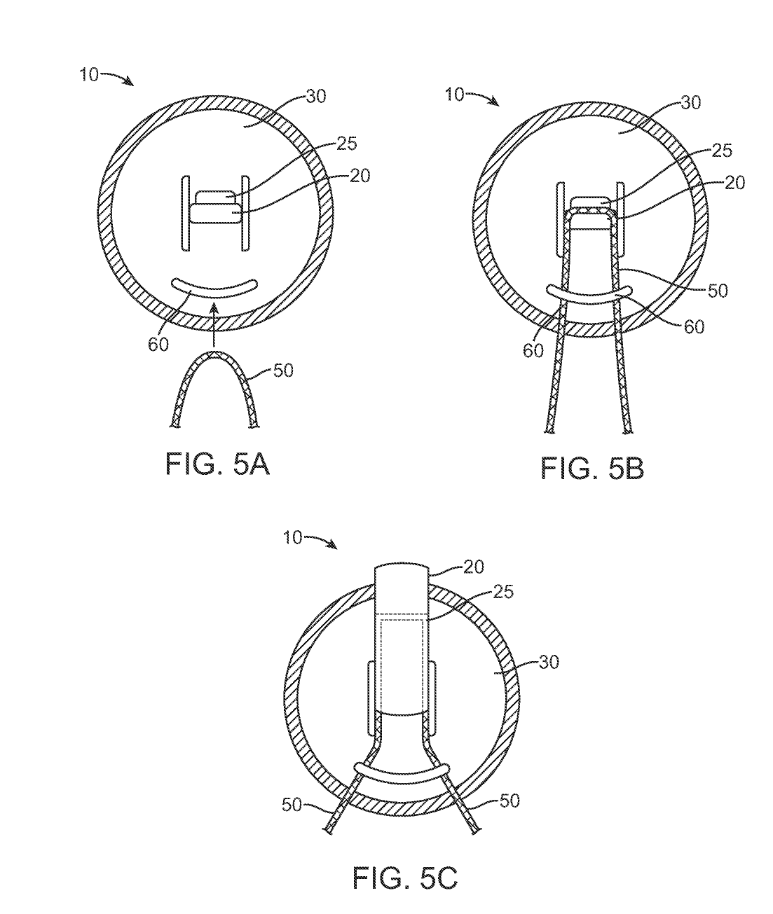

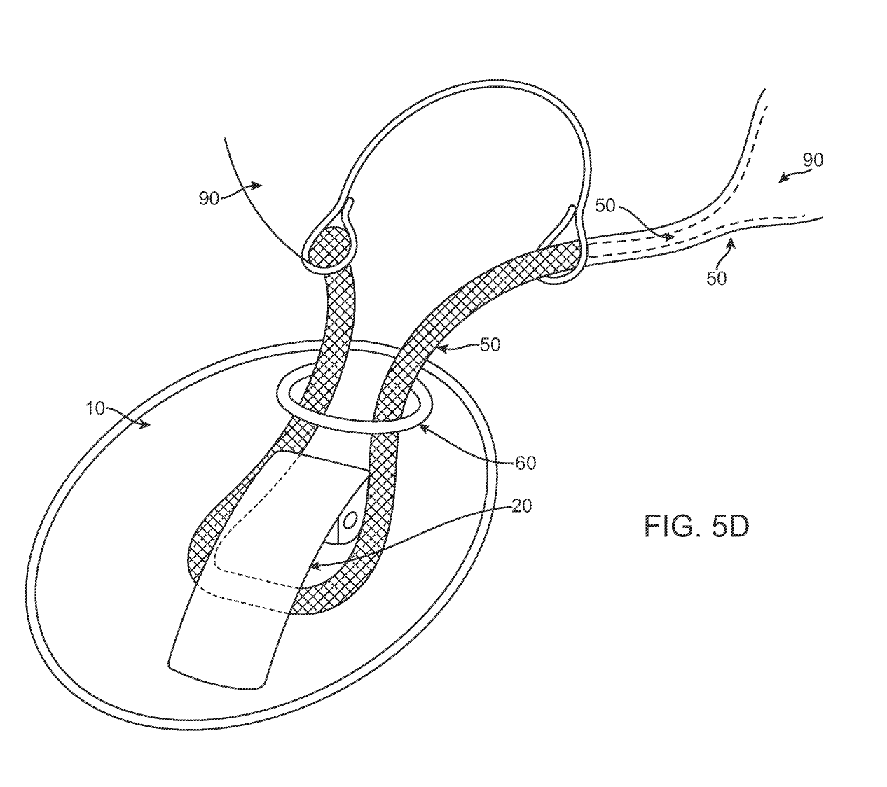

The suction device 10 can find many uses. For example, as shown in FIG. 5, the suction device 10 and the tether 50 can be used to attach a tarpaulin 90 to a truck bed T in a method similar to those described in U.S. patent application Ser. No. 11/271,678, filed Nov. 14, 2008 and entitled “Truck Bed Tarp System,” the entire contents of which are incorporated herein by reference. Many currently available truck beds have tie-downs located in the truck bed. To tie a tarpaulin down, the tarpaulin is secured within the truck bed, allowing the possibility of water, dirt, or other particles to get into the bed and into the covered items. By contrast, a plurality of suction devices 10 can be placed around the perimeter of the truck bed T, avoiding this problem. The tarpaulin 90 is placed over the truck bed T and the tether 50 is passed through the edges of the tarpaulin 90. The tether 50 can be coupled to the suction devices 10 to secure the tether 50 and the tarpaulin 90 to the truck bed T.

In many embodiments, the tether 50 of the tarpaulin 90 is formed as a continuous loop passing through the perimeter of the tarpaulin 90 like a drawstring. The continuous loop tether 50 may extend out of the corners of the tarpaulin 90. A suction device 10 may be provided for each of the parts of the tarpaulin 90 where the continuous loop tether extend out of. FIGS. 5A to 5C show a method of securing the continuous loop tether 50 using the suction device 10. As shown in FIG. 5A, a loop of the tether 50 is passed through the ring 60. As shown in FIG. 5B, the loop of the tether 50 is then hooked onto a cleat 25 which captures the tether 50. As shown in FIG. 5C, the suction device 10 is put into its locked configuration by closing lever 20. This moves the cleat 25 horizontally with respect to the base 30 to cinch the captured tether 50 and tighten it.

FIG. 5D shows a magnified view of the suction device 10 attaching the tarpaulin 90 to a truck bed as in FIG. 5.

In many embodiments, one or more of the suction devices 10 can be used to hold an object down to a surface or compartment, for example, the truck bed T, much like a prior art bungee cord would be used.

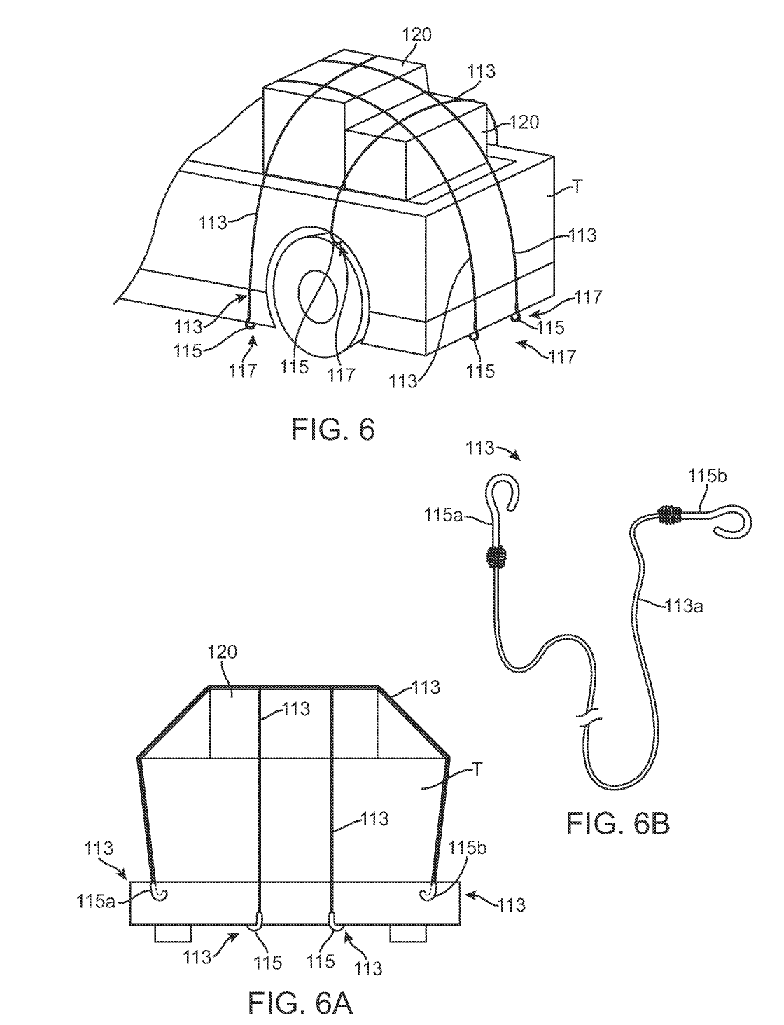

FIGS. 6 and 6A show a perspective view and a back view, respectively, of object 120 being held down to a truck bed using traditional bungee cords 113. FIG. 6B shows the traditional bungee cord 113. A traditional bungee cords 113 comprises an elastic cord 11 3a and hooks 115, for example, a first hook 115a at one end of the elastic cord 113a and a second hook 115b at a second end of the elastic cord 113a. To hold object 120 down, the hooks 115 must be hooked onto the underside of the truck bed T at anchor points 117. For example, to hold down the object 120, the first hook 115a may be anchored on one side of the truck bed T, the elastic cord 113 a is placed over the object 120, and the second hook 115b may be anchored on a second side of the truck bed T as shown in FIG. 6A. Depending on the size of the object 120, the traditional bungee cord 113 may have varying degrees of tension, for example, the traditional bungee cord 113 may be too loose on the object 120 and not properly hold down the object 120, or the traditional bungee cord 113 may be too tight on the object 120, potentially causing damage to the object 120 and increasing the chance of the bungee cord springing loose and causing injury to a nearby person, or may even not be long enough to hold the object 120 down.

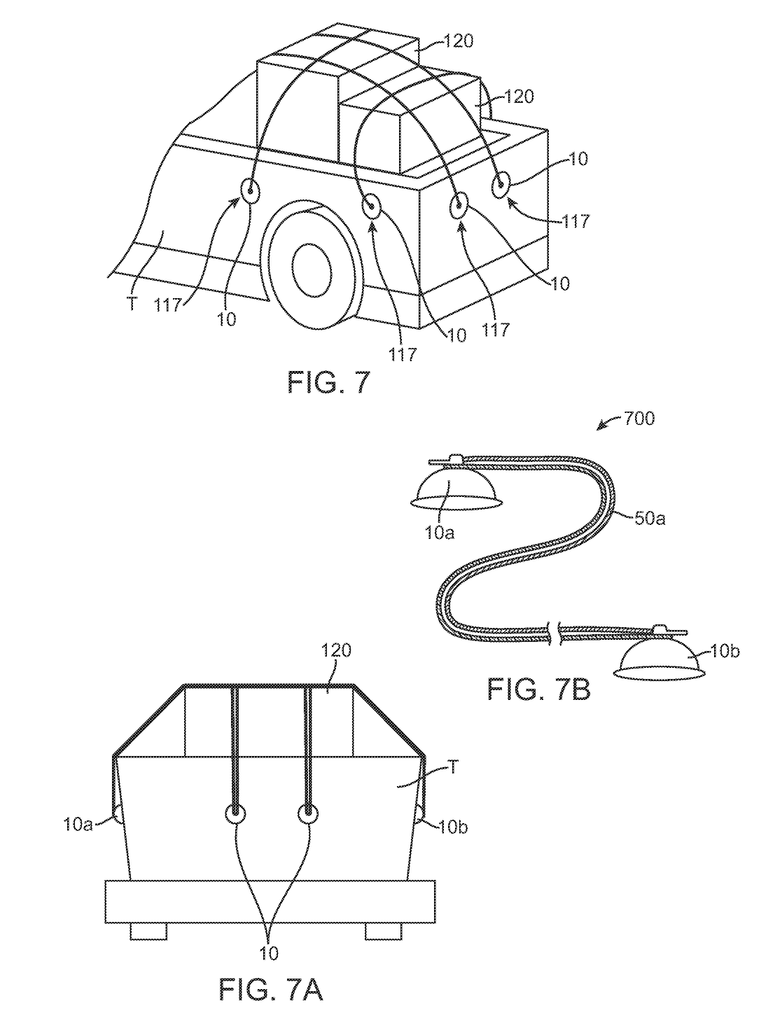

FIGS. 7 and 7A show a perspective view and a back view, respectively, of objects 120 held down to a truck bed T using a system 700 comprising suction devices 10 described above. FIG. 7B shows the suction device system 700. The suction device system 700 comprises a first suction device 10a, a second suction device 10b, and a continuous loop of tether 50a. The continuous loop of tether 50 can be secured through the first suction device 10a and the second suction device 10b as described above with reference to FIGS. 5A to 5C.

The suction device 700 can be used to hold down the object 120 on a surface or compartment, for example the truck bed T, in many ways. In one embodiment, the first suction device 10a is adhered to a first side of a surface adjacent the object 120, for example, a first side of the truck bed T. The second suction device 10b is adhered to a second side of the surface adjacent the object 120, for example, a second side of the truck bed T. The continuous loop of tether 50a is hooked onto a cleat of the first suction device 10 as described above with reference to FIGS. 5A to 5C. The continuous loop of tether 50a is placed and pulled over the object 120. The continuous loop of tether 50a is then hooked onto a cleat of the second suction device 10 as described above with reference to FIGS. 5A and 5C. The first and second suction devices 10a, 10b can then be placed into their locked configurations from their unlocked configurations as described above. Although only the above exemplary steps are described, it can be appreciated by those of ordinary skill in the art that the above-described steps may be performed in any order, additional related steps may be performed, and certain steps may be modified or omitted.

As the suction device can be placed anywhere on a target surface, for example, anywhere along the side of the truck bed T, the anchor points 117 of the suction devices 10 can be anywhere as well. Thus, an appropriate amount of tension for the continuous loop of tether 50a can be selected, making the system 700 more appropriate for holding down the object 120 without being too tight or too loose on the object 120 and reducing the chance occurrence of the tether 50a springing loose and potentially causing injury.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the invention. Therefore, the above description should not be taken as limiting the scope of the invention which is defined by the appended claims.

What is claimed is:

1. A suction device for adhering and securing a tether to a surface, the suction device comprising:
a base having a top portion and a bottom cavity;
a lever having a bottom end, a cam element pivotally coupled to the bottom end of the lever and traversing the top portion of the base, and at least one cleat along a side of the lever for capturing the tether;
a flexible suction skirt disposed within the bottom cavity of the base and coupled to the cam element of the lever, said flexible suction skirt being coupled to the cam element of the lever so that closing the lever from a vertical orientation relative to the base to a horizontal orientation relative to the base causes the cam element to pull the flexible suction skirt to deform the flexible suction skirt to apply suction on the surface,
wherein closing the lever also moves the at least one cleat of the lever horizontally with respect to the base to cinch the tether captured by the at least one cleat.

2. The suction device of claim 1, further comprising a ring coupled to the base for the tether to thread through.

3. The suction device of claim 1, wherein the at least one cleat of the lever comprises a plurality of cleats.

4. The suction device of claim 1, wherein the at least one cleat of the lever is oriented to face away from the base.

5. The suction device of claim 1, wherein the lever comprises a lever arm and the at least one cleat is offset from the elongate lever arm to form at least one hook for capturing the tether.

6. A method of adhering and securing a tether to a surface with a suction device, the method comprising:
placing a peripheral portion of a flexible suction skirt of the suction device adjacent the surface;
capturing the tether with at least one cleat of a lever of the suction device; and
closing the lever of the suction device from a vertical orientation relative to a base of the suction device to a horizontal orientation relative to the base of the suction device,
wherein closing the lever causes a cam element coupled to the lever of the suction device to pull a middle portion of the flexible suction skirt away from the peripheral portion of the flexible suction skirt to deform the flexible suction skirt to apply suction on the surface, and
wherein closing the lever also moves the at least one cleat of the lever horizontally with respect to the base to cinch the captured tether.

7. The method of claim 6 wherein capturing the tether comprises passing the tether through a ring of the suction device, said ring being coupled to the base of the suction device.

8. The method of claim 6 wherein capturing the tether with at least one cleat comprises hooking the tether onto the at least one cleat.

9. The method of claim 6 wherein the at least one cleat of the lever comprises a plurality of cleats.

10. The method of claim 6 wherein capturing the tether comprises:
passing the tether through a ring of the suction device in a first direction toward the lever of the suction device, said ring being coupled to the base of the suction device;
hooking the tether onto the at least one cleat; and
passing the tether through the ring of the suction device in a second direction away from the lever of the suction device.

11. A system for holding down an object to a surface, the system comprising:
a continuous loop of tether;
a first suction device as in claim 1, the first suction device capturing the continuous loop of tether; and
a second suction device as in claim 1, the second suction device also capturing the continuous loop of tether,
wherein the first suction device is adhered to the surface adjacent a first side of the object, the continuous loop of tether is placed over the object, and the second suction device is adhered to the surface adjacent a second side of the object to hold down the object to the surface.

12. A method of holding down an object to a surface, the method comprising:
placing a peripheral portion of a flexible suction skirt of a first suction device adjacent the surface at a first side of the object;
placing a peripheral portion of a second suction device adjacent the surface at a second side of the object;
capturing a continuous loop of tether with at least one cleat of a lever of the first suction device;
placing the continuous loop of tether over the object;
capturing the continuous loop of tether with at least one cleat of a lever of the second suction device; and
closing the levers of the first and second suction devices from a vertical orientation relative to bases of the first and second suction devices to a horizontal orientation relative to the bases of the first and second suction devices,
wherein closing the lever causes cam elements coupled to the levers of the first and second suction devices to pull middle portions of the flexible suction skirts of the first and second suction devices away from the peripheral portion of the flexible suction skirts of the first and second suction devices to deform the flexible suction skirts to apply suction on the surface, and
wherein closing the lever also moves the at least one cleat of the levers of the first and second suction devices horizontally with respect to the bases of the first and second suction devices to cinch the captured tether.

13. The method of claim 12 wherein capturing the continuous loop of tether with at least one cleat of a lever of the first suction device comprises passing the continuous loop of tether through a ring of the first suction device, said ring being coupled to the base of the first suction device.

14. The method of claim 12 wherein capturing the continuous loop of tether with at least one cleat of a lever of the second suction device comprises passing the continuous loop of tether through a ring of the second suction device, said ring being coupled to the base of the second suction device.

15. The method of claim 12 wherein capturing the continuous loop of tether with at least one cleat of a lever of the first suction device comprises hooking the tether onto the at least one cleat of the first suction device.

16. The method of claim 12 wherein capturing the continuous loop of tether with at least one cleat of a lever of the second suction device comprises hooking the tether onto the at least one cleat of the second suction device.
